(19) United States
(12) Patent Application Publication
(10) Pub. No.: US 2003/0208776 A1
(43) Pub. Date: Nov. 6, 2003

(54) Method for delivering a high speed internet connection

(76) Inventor: Sundaram Ramakesavan, Foster City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/140,310

(22) Filed: May 6, 2002

(51) Int. Cl. H04N 7/173

(52) U.S. Cl. 725/126; 725/110; 725/133; 725/111

(57) ABSTRACT

According to one embodiment, a system is disclosed. The system includes a customer premises and a headend coupled to the customer premises. The headend provides dedicated wide uplink and downlink channels to the first customer premises for access to a network and provides narrow dedicated channels of television program feeds.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to computer networking; more particularly, the present invention relates to increasing bandwidth in a high-speed network connection.

### BACKGROUND

Currently, millions of home personal computer (PC) users connect to the public Internet using a cable modem for high-speed access. A cable modem implements a wide channel (e.g., 6-8 MHz) for the downlink (data received at a PC from the Internet) and a multitude of narrower channels (e.g., 2-3 Mhz) for the uplink (data transmitted from the PC to the Internet).

The problem with current cable modems is that they do not provide sufficient bandwidth for high quality video conferencing. Moreover, if a large number of users begin to use video conferencing, cable access to the Internet would become very slow and inefficient. Consequently, the biggest problem preventing the introduction of high quality video conferencing using the Internet is the prohibitive cost of deploying high-speed links to users.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a network;

FIG. 2 illustrates exemplary cable channels;

FIG. 3 illustrates one embodiment of a cable system;

FIG. 4 is a block diagram for one embodiment of a customer premises;

FIG. 5 is a block diagram for one embodiment of a cable modem;

FIG. 6 illustrates one embodiment of received cable channels; and

FIG. 7 is a flow diagram for one embodiment of the operation of a cable system.

### DETAILED DESCRIPTION

A method for providing a high-speed network connection is described. According to one embodiment, hundreds of dedicated cable television channels are replaced by dedicated high bandwidth downlink and uplink channels for network access. The television channels are limited to a small finite quantity received at any one time.

However, all channels provided by a cable company are accessible by a cable user selecting a television channel at a set-top box. The channel selection is transmitted to a cable modem with a channel being used by a display device. The channel selection and the channel being used by the display device is transmitted to a headend. The headend examines the selection request and transmits the selected channel back to the cable modem on the channel being used by the display device. Subsequently, the selected channel is displayed at display device 410.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

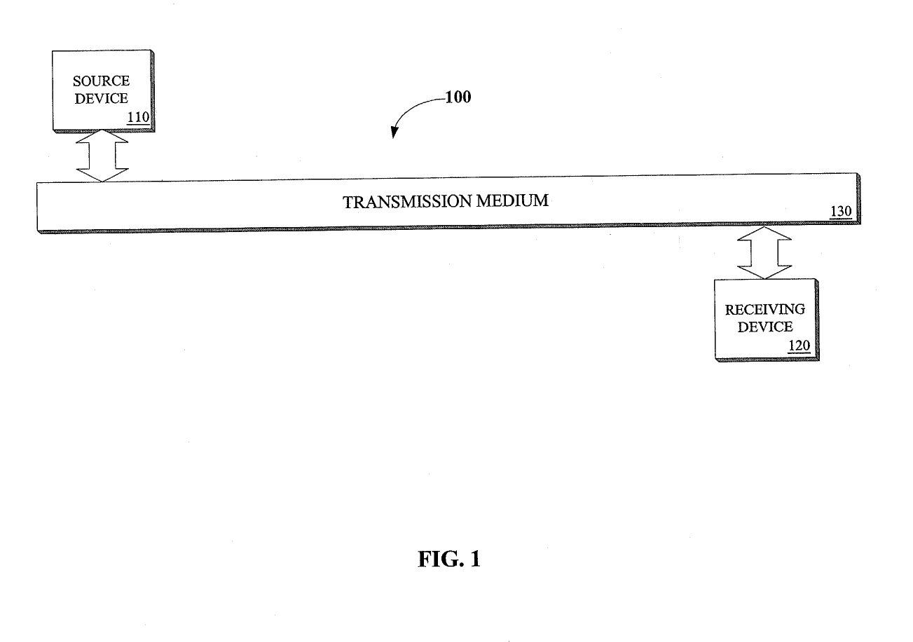

FIG. 1 illustrates one embodiment of a network 100. Network 100 includes a device 110 and a computer system 120 coupled via a transmission medium 130. In one embodiment, computer system 110 operates as a source device that transmits data to computer system 120, operating as a receiving device. The data may be, for example, a data file, an executable, audio, video or other types of data.

The data is transmitted via data transmission medium 130. The data transmission medium 130 may be one of many mediums such as an internal network connection, an Internet connection, or other connections. The transmission medium 130 may be connected to a plurality of untrusted routers (not shown) and switches (not shown).

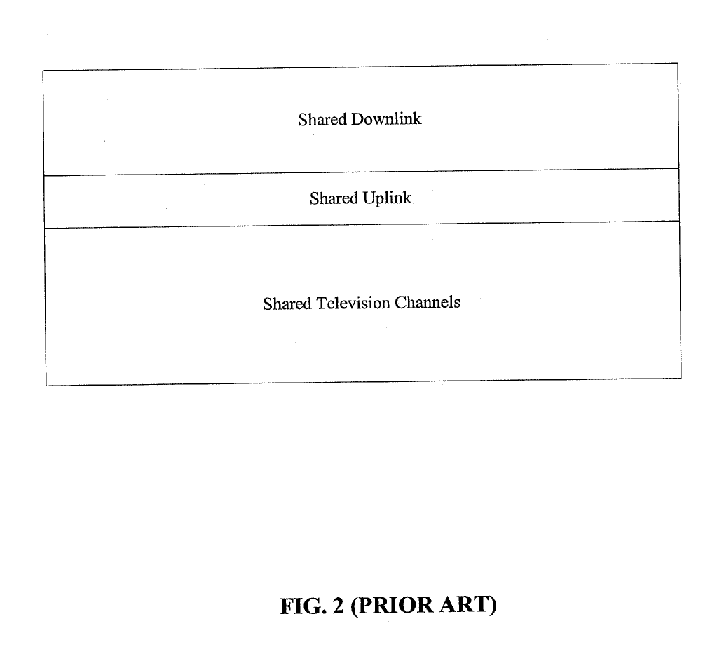

According to one embodiment, computer system 120 includes a cable modem that provides access to computer system 110 via a cable television line. FIG. 2 illustrates an exemplary cable channel distribution. As discussed above, a cable modem uses a wide channel for a downlink and a plurality of narrower channels for an uplink.

The downlink has a higher throughput than the uplink channels. The downlink and uplink channels are shared by a community of households. Meanwhile, the remainder of the channels (e.g., 100-200) is used for television broadcasts. The provision of such a large number of television channels restricts the implementation of high bandwidth Internet applications, such as video conferencing, via the downlink and uplink channels.

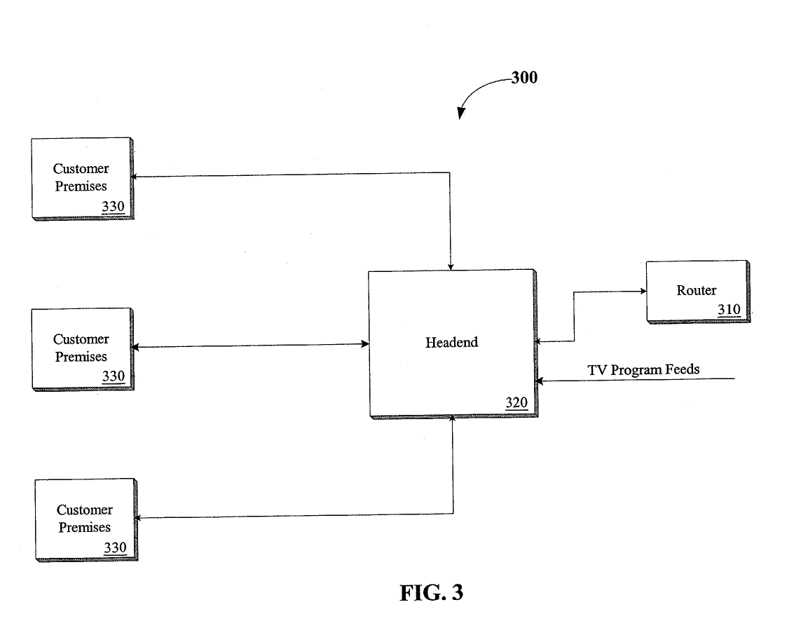

FIG. 3 illustrates one embodiment of a cable system 300. Cable system 300 includes a router 310, headend 320, and customer premises 330. Router 310 determines the next network point to which a data packet traveling through network 100 should be forwarded toward its destination. In particular, router 130 s data packets between source devices and headend 320.

Headend 320 is a central distribution point for cable system 300. Headend 300 is operated by a service provider (e.g., a cable company) and receives television program feeds facilitated by the service provider. Audio and video signals from satellites and other sources are received at headend 320 as television program feeds. Headend 320 converts the source frequency to appropriate channels and combines the channels with locally originated signals. Subsequently, the channels are rebroadcast onto a network of cable (e.g. a hybrid fiber coaxial (HFC) plant).

According to one embodiment, headend 320 includes a Cable Modem Termination System (CMTS), not shown. The CMTS is a central device for connecting the cable TV network to a data network like the Internet. Customer premises 330 receives Internet and television services from headend 320. In one embodiment, customer premises 330 represents residential customers. However, in other embodiments, customer premises 330 may also represent business customers.

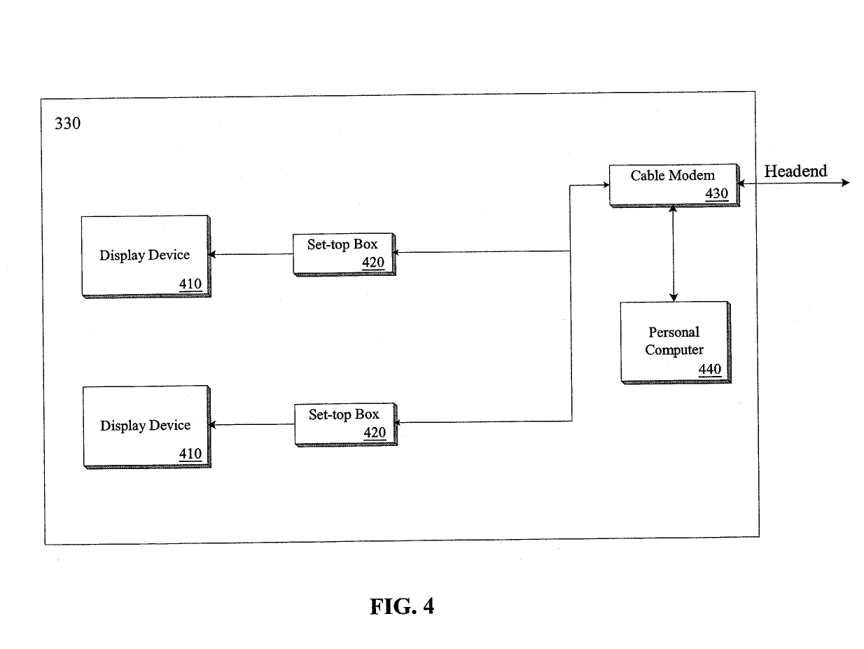

FIG. 4 is a block diagram for one embodiment of a customer premises. Customer premises 330 includes display devices 410, set-top boxes 420, cable modem 430 and personal computer (PC) 440. Display devices 410 receive data signals from connected set-top boxes 420 and displays the information and data signals to a user at customer premises 330. In one embodiment, display devices are television sets. However, in other embodiments, one or more of the display devices 410 may be a computer monitor, a flat panel display or other display device.

Set-top boxes 420 are implemented to receive cable television services from headend 320. According to one embodiment, set-top boxes 420 capture channel selections made by users at customer premises 330 and forwards the selection to cable modem 430. Cable modem 430 enables PC 440 to connect with the CMTS within headend 320 in order to gain access to a network such as the Internet. According to one embodiment, cable modem 430 is external to PC 440 and set-top boxes 420. However, in other embodiments, cable modem 430 may be integrated within a set-top box 420 or PC 440.

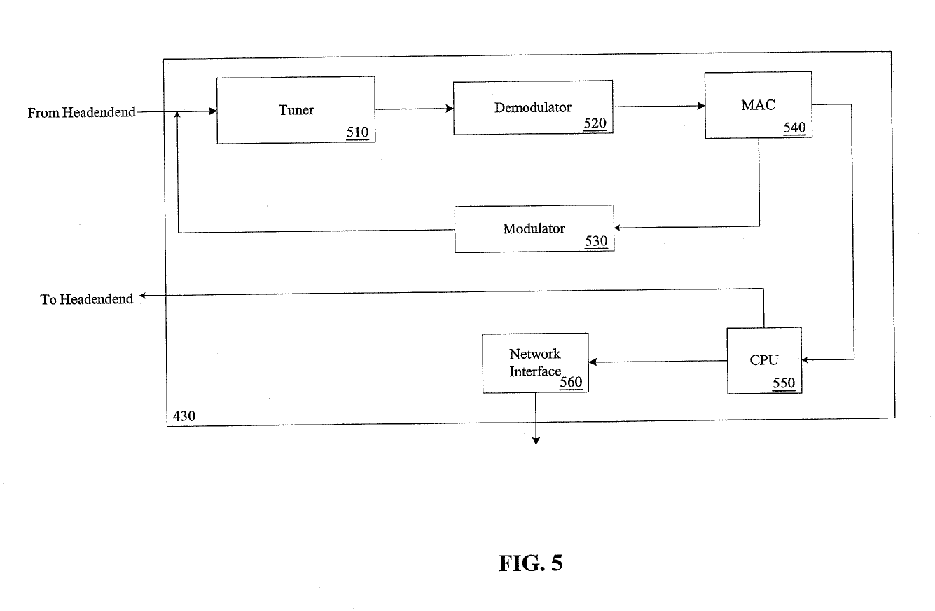

FIG. 5 is a block diagram of one embodiment of cable modem 430. Cable modem 430 includes tuner 510, demodulator 520, modulator 530, media access control (MAC), central processing unit (CPU) 550 and network interface 560. Tuner 510 connects cable modem 430 with headend 320. Tuner 510 receives a modulated digital signal and passes it to demodulator 520. In one embodiment, tuner 510 includes a diplexer, not shown, that allows tuner to make use of one set of frequencies (generally between 42 and 850 MHz) for downstream traffic, and another set of frequencies (between 5 and 42 MHz) for the upstream data.

Demodulator 520 demodulates a radio-frequency signal that includes encoded information by varying both the amplitude and phase of the wave, and turns it into a simple signal that can be processed by an analog-to-digital (A/D) converter. The A/D converter takes the analog signal, and converts the signal into a digital signal. According to one embodiment, demodulator includes an error correction module, not shown, that checks the received information against a known standard, so that problems in transmission can be found and fixed.

Modulator 530 converts digital network data into radio-frequency signals for transmission. In one embodiment, modulator 530 is a burst modulator. Further, modulator 530 includes a digital-to-analog (D/A) converter to convert the digital signals into an analog format.

MAC 540 sits between the upstream and downstream portions of cable modem 430, and functions as the interface between the hardware and software portions of various network protocols. CPU 550 processes data signals received at cable modem 430. According to one embodiment, CPU 550 assists MAC 540 in processing complex functions. In a further embodiment, CPU 550 receives channel selections from a set-top box 420 in order to acquire television channels. Network interface 560 serves as an interface between cable modem 430 and PC 440.

Typically, only two to four television channels are actually used for viewing or recording at any one time. Thus, the traditional reception of hundreds of television channels at a customer premises 330 is a waste of resources. According to one embodiment, cable modem 430 enables a user at a customer premises 330 to have a high speed Internet access sufficient for unlimited high quality video conferencing.

In such an embodiment, only a small number of television channels are received at a customer premises 330 for viewing or recording at any one time. According to a further embodiment, a user at a customer premises 330 may select all of the television broadcasts provided by the cable company. Thus, a user will not suffer any television program limitations with the reduced number of received television channels.

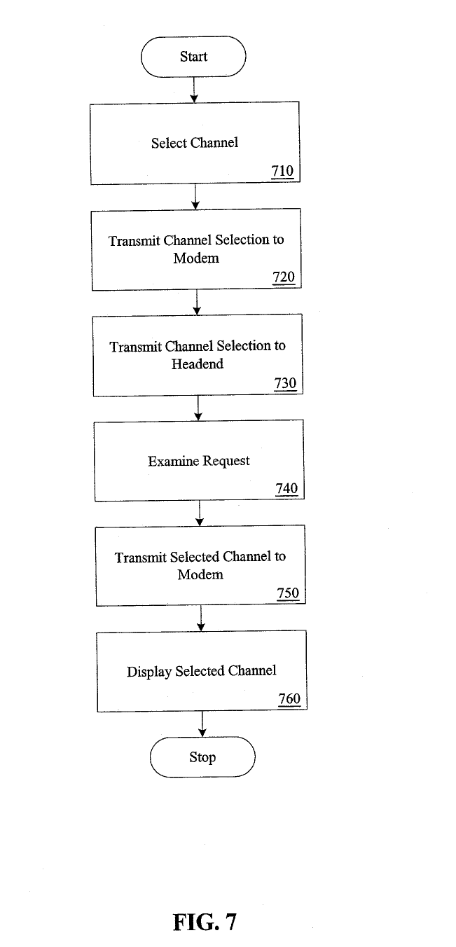

FIG. 7 is a flow diagram of one embodiment for television channel selections at a customer premises 330. At processing block 710, a cable user selects a television channel. The channel selection may be done remotely using a remote control device, or manually by inputting the selection at a set-top box 420. At processing block 720, the channel selection, along with the channel being used by the display device 410 (or video recorder), is transmitted to cable modem 430.

At processing block 730, the channel selection and the channel being used by the display device 410 is transmitted to headend 320. At processing block 740, headend 320 examines the selection request. At processing block 750, the selected channel is transmitted back to cable modem 430 on the channel being used by the display device 410. At processing block 760, the selected channel is displayed at display device 410.

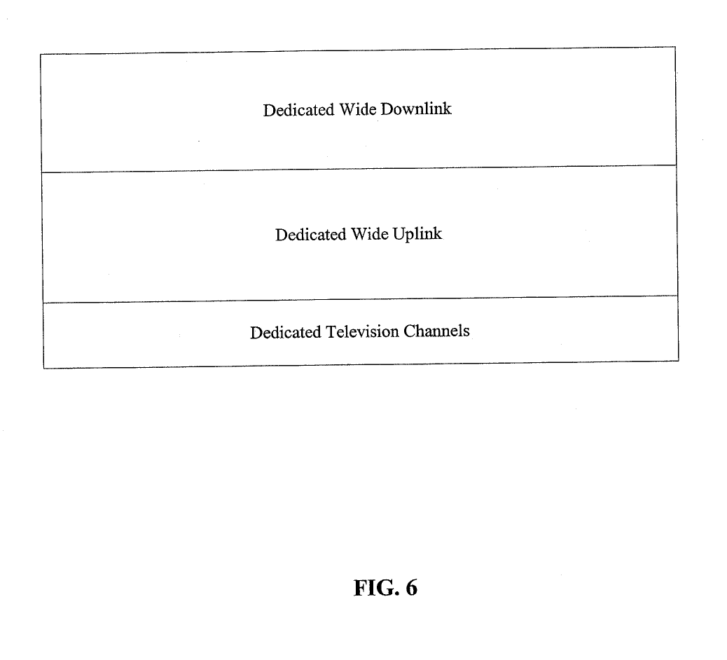

FIG. 6 illustrates one embodiment of cable channels received at a customer premises 330. The received cable channels include dedicated wide downlink and uplink channels. In addition, a finite number of dedicated television channels are provided. In one embodiment, five dedicated television channels are provided. However, one of ordinary skill in the art will appreciate that other quantities of television channels may be provided.

Since the number of received television channels are limited to less than five, dedicated Internet data can be delivered to each customer premises 330. The dedicated Internet data is implements a wide bandwidth of between fifty to one hundred channels.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. A system comprising:
a first customer premises; and
a headend, coupled to the first customer premises, that provides dedicated wide uplink and downlink channels to the first customer premises for access to a network and provides dedicated narrow channels of television program feeds.

2. The system of claim 1 wherein a broad range of television program feeds are received at the headend and the headend selects a subset of the broad range of television program feeds to transmit to the first customer premises as the dedicated narrow channels of television program feeds.

3. The system of claim 1 wherein the first customer premises acquires the television program feeds upon receiving a user selection.

4. The system of claim 3 wherein the customer premises comprises:
a modem coupled to the headend that acquires the television program feeds; and
a set-top box, coupled to the modem, that transmits the user selection to the modem.

5. The system of claim 4 wherein the customer premises further comprises a display device coupled to the set-top box.

6. The system of claim 4 wherein the customer premises further comprises a personal computer (PC) coupled to the modem.

7. The system of claim 4 wherein the headend comprises a Cable Modem Termination System (CMTS) that connects the first customer premises to a data network.

8. The system of claim 1 further comprising a second customer premises coupled to the headend.

9. A method comprising:
receiving dedicated wide uplink and downlink cable channels at a customer premises from a headend; and
receiving dedicated narrow channels of television program feeds from the headend, the dedicated narrow channels of television program feeds being a subset of a broad range of television program feeds received at the headend.

10. The method of claim 9 wherein receiving dedicated narrow channels of television program feeds comprises:
selecting a first channel at a set-top box;
transmitting the channel selection to the headend; and
receiving the selected channel at the set-top box.

11. The method of claim 10 further comprising displaying the selected channel at a display device.

12. The method of claim 10 wherein transmitting the channel selection to the headend comprises:
receiving the channel selection from the set-top box at a modem;
receiving a channel being used at a display device at the modem; and
transmitting the channel selection and the channel being used at the display device to the headend.

13. The method of claim 12 further comprising:
receiving the selected channel at the modem;
receiving a channel being used at a display device at the modem on the channel being used by the display device; and
transmitting the selected channel to the set-top box; and
displaying the selected channel at a display device.

14. A customer premises comprising:
a modem that receives dedicated wide uplink and downlink cable channels and dedicated narrow channels of television program feeds from a headend; and
a set-top box, coupled to the modem, that transmits a channel selection to the modem and receives the narrow channels of television program feeds.

15. The customer premises of claim 14 wherein the dedicated narrow channels are a subset of a broad range of television program feeds received at the headend.

16. The s customer premises of claim 14 wherein the customer premises further comprises a display device coupled to the set-top box.

17. The customer premises of claim 14 wherein the customer premises further comprises a personal computer (PC) coupled to the modem.
